(19) United States
(12) Patent Application Publication
(10) Pub. No.: US 2024/0053611 A1
(43) Pub. Date: Feb. 15, 2024

(54) Latency Correction for a Camera Image

(71) Applicant: Apple Inc., Cupertino, CA (US)

(72) Inventor: Gregory Lutter, Boulder Creek, CA (US)

(21) Appl. No.: 18/339,073

(22) Filed: Jun. 21, 2023

Related U.S. Application Data
(60) Provisional application No. 63/398,024, filed on Aug. 15, 2022.

(51) Int. Cl. G02B 27/01; G06T 7/73; G06T 19/00

(52) U.S. Cl. CPC G02B 27/0172; G06T 7/74; G06T 19/006; G02B 2027/011; G02B 2027/0138; G06T 2207/10004

(57) ABSTRACT

A camera in a head-mounted device may capture images of a physical environment surrounding the head-mounted device. The images captured by the camera may sometimes be displayed on a transparent display in the head-mounted device. In one example, a video feed from the camera may be displayed on the display at a position that causes the video feed to overlap corresponding portions of the head-mounted device. The video feed may be displayed as part of a camera application, as one example. There may be latency between the capturing of the video feed by the camera and the display of the video feed on the display. To mitigate discomfort caused by latency, each image in the video feed from the camera may be displayed based on a pose of the head-mounted device at the time that image is captured.

This application claims priority to U.S. provisional patent application No. 63/398,024, filed Aug. 15, 2022, which is hereby incorporated by reference herein in its entirety.

### BACKGROUND

This relates generally to head-mounted devices, and, more particularly, to head-mounted devices with displays.

Some electronic devices such as head-mounted devices include displays that are positioned close to a user's eyes during operation (sometimes referred to as near-eye displays). A head-mounted device may include one or more cameras to capture images of a physical environment around the head-mounted device. If care is not taken, latency may cause artifacts and/or discomfort to a user viewing images from the camera on the head-mounted device.

### SUMMARY

An electronic device may include one or more sensors, one or more displays, one or more processors, and memory storing instructions configured to be executed by the one or more processors, the instructions for: capturing, using a first subset of the one or more sensors, an image of a physical environment, obtaining, using a second subset of the one or more sensors, a first pose of the electronic device, wherein the first pose is associated with the capturing of the image of the physical environment, determining, based on the first pose of the electronic device, a position for a representation of the image within a three-dimensional (3D) environment, and presenting, using the one or more displays, a view of the 3D environment based on a second pose of the electronic device different than the first pose, wherein the view comprises the representation of the image at the determined position.

### BRIEF DESCRIPTION OF THE DRAWINGS

FIG. 1 is a schematic diagram of an illustrative head-mounted device in accordance with some embodiments.

FIGS. 2A-2C are diagrams of an illustrative user of a head-mounted device showing how the user's head pose may be defined by yaw, roll, and pitch, respectively in accordance with some embodiments.

FIG. 3A is a view of an XR environment with a head-mounted device and a physical object at a first time in accordance with some embodiments.

FIG. 3B is a diagram showing the view of a user of the head-mounted device in FIG. 3A in accordance with some embodiments.

FIG. 4A is a view of the XR environment of FIG. 3A at a second time in a head-mounted device without latency correction in accordance with some embodiments.

FIG. 4B is a diagram showing the view of a user of the head-mounted device in FIG. 4A in accordance with some embodiments.

FIG. 5A is a view of the XR environment of FIG. 3A at a second time in a head-mounted device with latency correction in accordance with some embodiments.

FIG. 5B is a diagram showing the view of a user of the head-mounted device in FIG. 5A in accordance with some embodiments.

FIG. 6 is a diagram of an illustrative head-mounted device where pose information is included as metadata in each image output by a camera in accordance with some embodiments.

FIG. 7 is a diagram of an illustrative head-mounted device where a time stamp is included as metadata in each image output by a camera and control circuitry in the head-mounted device includes a pose buffer in accordance with some embodiments.

FIG. 8 is a diagram of an illustrative head-mounted device with control circuitry that includes a pose buffer and a stored latency magnitude in accordance with some embodiments.

FIG. 9 is a view of an illustrative display in a head-mounted device when an image from a camera on the head-mounted device is presented as part of a camera application in accordance with some embodiments.

FIG. 10 is a flowchart showing an illustrative method performed by a head-mounted device in accordance with some embodiments.

### DETAILED DESCRIPTION

Head-mounted devices may display different types of extended reality content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field-of-view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

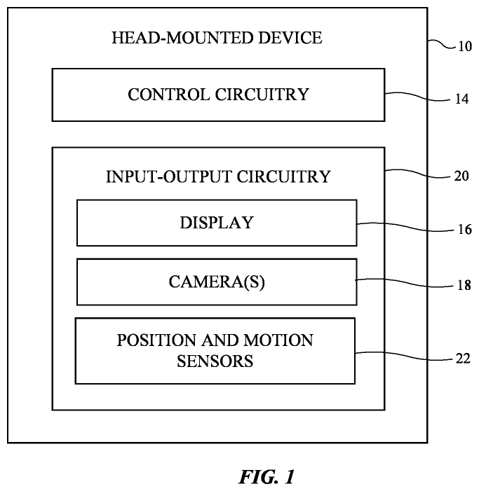

A schematic diagram of an illustrative head-mounted device is shown in FIG. 1. As shown in FIG. 1, head-mounted device 10 (sometimes referred to as electronic device 10, system 10, head-mounted display 10, etc.) may have control circuitry 14. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 20. Input-output circuitry 20 may be used to allow data to be received by head-mounted device 10 from external equipment (e.g., a tethered computer, a portable device such as a handheld device or laptop computer, or other electrical equipment) and to allow a user to provide head-mounted device 10 with user input. Input-output circuitry 20 may also be used to gather information on the environment in which head-mounted device 10 is operating. Output components in circuitry 20 may allow head-mounted device 10 to provide a user with output and may be used to communicate with external electrical equipment.

As shown in FIG. 1, input-output circuitry 20 may include a display such as display 16. Display 16 may be used to display images for a user of head-mounted device 10. Display 16 may be a transparent display so that a user may observe physical objects through the display while computer-generated content is overlaid on top of the physical objects by presenting computer-generated images on the display. A transparent display may be formed from a transparent pixel array (e.g., a transparent organic light-emitting diode display panel) or may be formed by a display device that provides images to a user through a beam splitter, holographic coupler, or other optical coupler (e.g., a display device such as a liquid crystal on silicon display). Alternatively, display 16 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 16 is opaque, the display may also optionally display entirely computer-generated content (e.g., without displaying images of the physical environment).

Display 16 may include one or more optical systems (e.g., lenses) (sometimes referred to as optical assemblies) that allow a viewer to view images on display(s) 16. A single display 16 may produce images for both eyes or a pair of displays 16 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 20 may include various other input-output devices. For example, input-output circuitry 20 may include one or more cameras 18. Cameras 18 may include one or more outward-facing cameras (that face the physical environment around the user when the head-mounted device is mounted on the user's head). Cameras 18 may capture visible light images, infrared images, or images of any other desired type. The cameras may be stereo cameras if desired. Outward-facing cameras may capture pass-through video for device 10.

As shown in FIG. 1, input-output circuitry 20 may include position and motion sensors 22 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 22, for example, control circuitry 14 can monitor the current direction in which a user's head is oriented relative to the surrounding environment (e.g., a user's head pose). The outward-facing cameras in cameras 18 may also be considered part of position and motion sensors 22. The outward-facing cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 20 may also include other sensors and input-output components if desired (e.g., gaze tracking sensors, ambient light sensors, force sensors, temperature sensors, touch sensors, image sensors for detecting hand gestures or body poses, buttons, capacitive proximity sensors, light-based proximity sensors, other proximity sensors, strain gauges, gas sensors, pressure sensors, moisture sensors, magnetic sensors, microphones, speakers, audio components, haptic output devices such as actuators, light-emitting diodes, other light sources, wired and/or wireless communications circuitry, etc.).

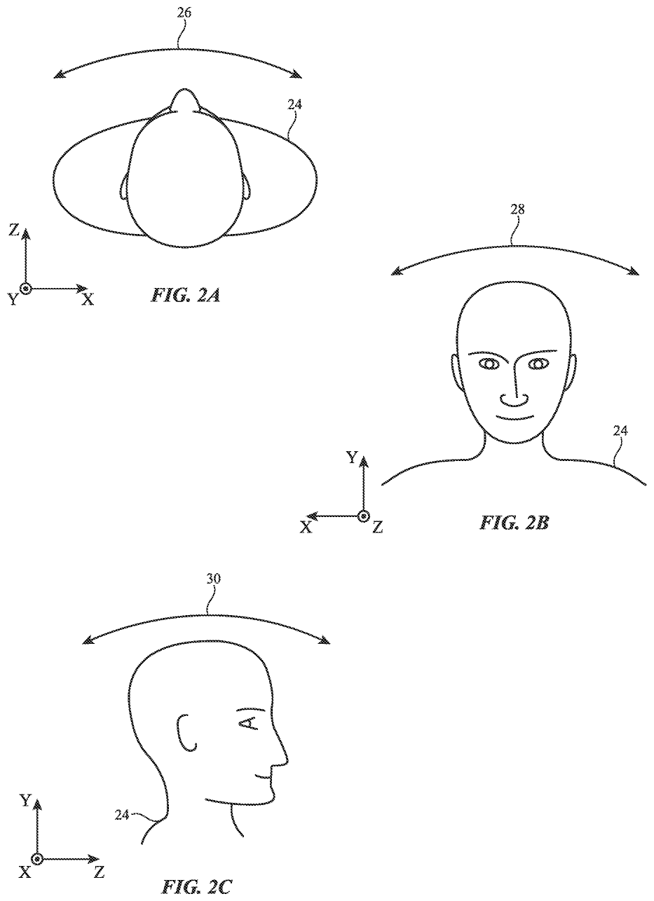

Position and motion sensors 22 may detect changes in head pose (sometimes referred to as head movements) during operation of head-mounted device 10. Changes in yaw, roll, and/or pitch of the user's head (and, correspondingly, the head-mounted device) may all be interpreted as user input if desired. FIGS. 2A-2C show how yaw, roll, and pitch may be defined for the user's head. FIGS. 2A-2C show a user 24. In each one of FIGS. 2A-2C, the user is facing the Z-direction and the Y-axis is aligned with the height of the user. The X-axis may be considered the side-to-side axis for the user's head, the Z-axis may be considered the front-to-back axis for the user's head, and the Y-axis may be considered the vertical axis for the user's head. The X-axis may be referred to as extending from the user's left ear to the user's right ear, as extending from the left side of the user's head to the right side of the user's head, etc. The Z-axis may be referred to as extending from the back of the user's head to the front of the user's head (e.g., to the user's face). The Y-axis may be referred to as extending from the bottom of the user's head to the top of the user's head.

As shown in FIG. 2A, yaw may be defined as the rotation around the vertical axis (e.g., the Y-axis in FIGS. 2A-2C). As the user's head rotates along direction 26, the yaw of the user's head changes. Yaw may sometimes alternatively be referred to as heading. The user's head may change yaw by rotating to the right or left around the vertical axis. A rotation to the right around the vertical axis (e.g., an increase in yaw) may be referred to as a rightward head movement. A rotation to the left around the vertical axis (e.g., a decrease in yaw) may be referred to as a leftward head movement.

As shown in FIG. 2B, roll may be defined as the rotation around the front-to-back axis (e.g., the Z-axis in FIGS. 2A-2C). As the user's head rotates along direction 28, the roll of the user's head changes. The user's head may change roll by rotating to the right or left around the front-to-back axis. A rotation to the right around the front-to-back axis (e.g., an increase in roll) may be referred to as a rightward head movement. A rotation to the left around the front-to-back axis (e.g., a decrease in roll) may be referred to as a leftward head movement.

As shown in FIG. 2C, pitch may be defined as the rotation around the side-to-side axis (e.g., the X-axis in FIGS. 2A-2C). As the user's head rotates along direction 30, the pitch of the user's head changes. The user's head may change pitch by rotating up or down around the side-to-side axis. A rotation down around the side-to-side axis (e.g., a decrease in pitch following the right arrow in direction 30 in FIG. 2C) may be referred to as a downward head movement. A rotation up around the side-to-side axis (e.g., an increase in pitch following the left arrow in direction 30 in FIG. 2C) may be referred to as an upward head movement.

It should be understood that position and motion sensors 22 may directly determine pose, movement, yaw, pitch, roll, etc. for head-mounted device 10. Position and motion sensors 22 may assume that the head-mounted device is mounted on the user's head. Therefore, herein, references to head pose, head movement, yaw of the user's head, pitch of the user's head, roll of the user's head, etc. may be considered interchangeable with references to references to device pose, device movement, yaw of the device, pitch of the device, roll of the device, etc.

At any given time, position and motion sensors 22 (and/or control circuitry 14) may determine the yaw, roll, and pitch of the user's head. The yaw, roll, and pitch of the user's head may collectively define the orientation of the user's head pose. Detected changes in head pose (e.g., orientation) may be used as user input to head-mounted device 10.

Images captured by camera 18 in head-mounted device 10 may sometimes be displayed on display 16 in head-mounted device 10. In one example, a video feed from camera 18 may be displayed on display 16 in head-mounted device 10. The video feed may be displayed as part of a camera application, as one example. There may be latency between the capturing of the video feed by camera 18 and the display of the video feed on display 16. This latency may not be noticeable to the user if the physical environment and the user's head pose remain static. However, if the physical environment and/or the user's head pose change, there may be a latency between the change occurring and the change being reflected on the video feed on display 16. To mitigate discomfort caused by latency, each image in the video feed from camera 18 may be displayed based on a pose of the head-mounted device at the time that image is captured.

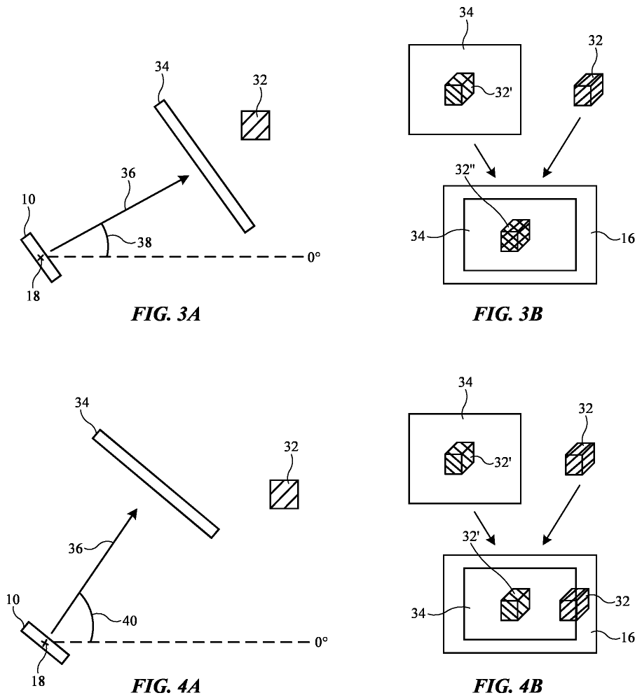

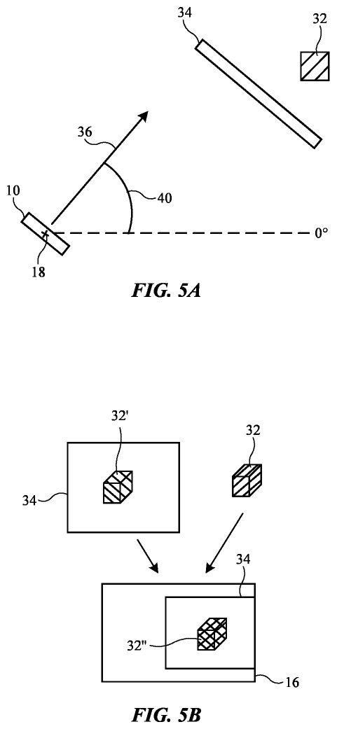

FIGS. 3A, 4A, and 5A are top views of an XR environment including a head-mounted device 10 with camera 18 and physical object 32. Physical object 32 is part of a physical environment that surrounds head-mounted device 10. FIG. 3A shows the XR environment at a first time t₁. FIG. 4A shows the XR environment at a second time t₂ (that is subsequent to the first time) in a head-mounted device without latency correction. FIG. 5A shows the XR environment at the second time t₂ (that is subsequent to the first time) in a head-mounted device with latency correction.

FIG. 3B is a diagram showing the view of a user of head-mounted device 10 in FIG. 3A. FIG. 4B is a diagram showing the view of a user of head-mounted device 10 in FIG. 4A. FIG. 5B is a diagram showing the view of a user of head-mounted device 10 in FIG. 5A.

In FIG. 3A, head-mounted device 10 (and camera 18) faces direction 36 which is at an angle 38 relative to a reference direction of 0 degrees. For illustration purposes, head-mounted device 10 and physical object 32 have been static for an extended period of time prior to t₁ in FIG. 3A.

In FIG. 3A, camera 18 faces physical object 32 and therefore captures images of physical object 32. A video feed from camera 18 may be displayed by display 16 in head-mounted device 10. In particular, the video feed from camera 18 may be displayed on a virtual panel 34 at an apparent depth from the head-mounted device.

Display 16 in FIG. 3B may be a transparent display and the physical environment (including physical object 32) is viewable through the transparent display. Virtual panel 34 (with the video feed from camera 18) may be displayed at a location that causes the video feed from camera 18 to overlap corresponding portions of the physical environment.

As shown in FIG. 3B, a virtual panel 34 (which includes an image 32′ of physical object 32 as captured by camera 18) is displayed on display 16. Physical object 32 is also viewable through the transparent display 16. The view presented to the user therefore appears to have a physical object 32″. Physical object 32″ is an overlay of light from image 32′ (sometimes referred to as display light) and light from physical object 32 itself (sometimes referred to as physical environment light).

It may be desirable to continuously display the video feed of physical environment 32 (captured by camera 18) on virtual panel 34. Virtual panel 34 may be positioned such that the captured images overlap corresponding portions of the physical environment. However, if care is not taken, latency may cause a mismatch between the virtual panel 34 and the physical environment. FIGS. 4A and 4B show an XR environment with latency-mismatch.

In FIG. 4A, head-mounted device 10 (and camera 18) faces direction 36 which is at an angle 40 relative to a reference direction of 0 degrees. In FIG. 4A, angle 40 is greater than the angle 38 from FIG. 3A. In other words, head-mounted device 10 has rotated (e.g., changed its yaw) between t₁ (in FIG. 3A) and t₂ (in FIG. 4A). The head-mounted device may have a yaw of 30 degrees in FIG. 3A and a yaw of 60 degrees in FIG. 4A, as one illustrative example.

Similar to FIG. 3A, the video feed from camera 18 may be displayed in FIG. 4A on a virtual panel 34 at an apparent depth from the head-mounted device. The virtual panel 34 in FIG. 4A may be displayed at the same position relative to the head-mounted device as in FIG. 3A (e.g., centered in front of the head-mounted device).

In FIG. 4A, physical object 32 is right-of-center for the field-of-view of camera 18. Accordingly, an image captured by camera 18 while head-mounted device 10 has the pose in FIG. 4A may result in the physical object appearing to the right-of-center of the image.

Ideally, real-time images from camera 18 would be displayed on the video feed on virtual panel 34, resulting in no mismatch between the displayed video feed and the overlayed physical environment. In other words, the virtual panel in FIGS. 4A and 4B at t₂ would display an image captured by camera 18 at t₂. However, in practice there may be latency between capturing images with camera 18 and displaying the images on virtual panel 34. Thus, as shown in FIG. 4B, the virtual panel in FIGS. 4A and 4B at t₂ may display an image captured by camera 18 at t₁. In FIG. 4B, the image 32′ on virtual panel 34 is actually captured at t₁ (when the physical object is centered within the field-of-view of the camera as shown in FIG. 3A at t₁).

As shown in FIG. 4B, physical object 32 is also viewable through the transparent display 16. The view presented to the user therefore has a mismatch between the physical object 32 and the image 32′ of the physical object. This type of mismatch (caused by latency) may cause undesired discomfort to the viewer.

To prevent this type of mismatch, an image for a video feed may be displayed at a position based on the pose of the head-mounted device when the image was captured. An arrangement of this type is shown in FIGS. 5A and 5B.

In FIG. 5A, head-mounted device 10 (and camera 18) faces direction 36 which is at an angle 40 relative to a reference direction of 0 degrees. Angle 40 in FIG. 5A is greater than the angle 38 in FIG. 3A and the same as angle 40 in FIG. 4A. In other words, head-mounted device 10 in FIG. 5A has rotated (e.g., changed its yaw) relative to FIG. 3A. The head-mounted device may have a yaw of 30 degrees in FIG. 3A and a yaw of 60 degrees in FIG. 5A, as one illustrative example.

The video feed from camera 18 may be displayed in FIG. 5A on a virtual panel 34 at a location that is based on the head pose at t₁. The virtual panel is positioned to cause the displayed images of the physical environment to overlap corresponding portions of the physical environment. As shown in FIG. 5B, the virtual panel 34 at t₂ may display an image captured by camera 18 at t₁ (when the physical object 32 is centered within the video feed as shown in FIG. 3A at t₁). Physical object 32 is also viewable through the transparent display 16. In FIG. 5B, the virtual panel 34 is positioned based on the pose of the device at t₁. Because the image on the virtual panel is also from t₁, the view presented to the user appears to have a physical object 32″. Physical object 32″ is an overlay of light from image 32′ (sometimes referred to as display light) and light from physical object 32 itself (sometimes referred to as physical environment light).

In other words, positioning virtual panel 34 (with an image captured at t₁) based on the head pose at t₁ while at a different head pose (at t₂) mitigates latency-caused mismatch.

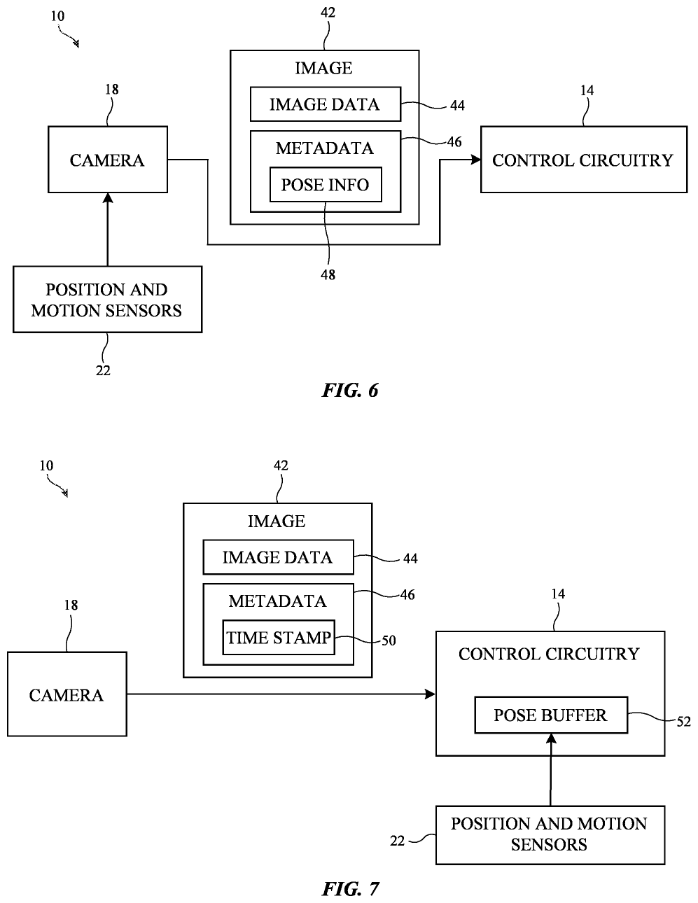

FIGS. 6-8 show possible arrangements for a head-mounted device that positions an image of a physical environment based on a pose of the head-mounted device when the image of the physical environment was captured. In FIG. 6, head-mounted device 10 includes a camera 18 that outputs a series of images 42 (e.g., a video feed) to control circuitry 14. The camera may be an outward-facing camera in device 10. The camera may be a stereo camera if desired. Each image includes image data 44. The image data may be the actual image of the physical environment captured by camera 18 (e.g., with brightness information for each pixel within camera 18). Each image 42 may also include metadata 46. Metadata 46 may include data that describes and gives information about image data 44.

In FIG. 6, position and motion sensors 22 may determine and provide pose information for head-mounted device 10 directly to camera 18. Camera 18 may output pose information 48 in each image 42 within metadata 46. In other words, each image has an encoded associated pose for head-mounted device 10 in its metadata. Upon receiving an image 42, control circuitry 14 may extract the pose information 48 from metadata 46 and use pose information 48 to determine a position for a representation of image data 44 on display 16.

Another possible arrangement for head-mounted device 10 is shown in FIG. 7. In this arrangement, control circuitry 14 includes a pose buffer 52 (sometimes referred to as buffer 52). Position and motion sensors 22 may provide pose information for head-mounted device 10 at a series of discrete time points to pose buffer 52. The poses at the various time points are stored in buffer 52. Each pose stored in buffer 52 may be time stamped. For example, pose buffer 52 may store the pose of head-mounted device 10 every 0.05 seconds for the last two seconds (i.e., 40 historical poses are stored in buffer 52). This example is merely illustrative. In general, any desired number of poses at any desired increments (e.g., regular increments or irregular increments) may be stored in buffer 52. Buffer 52 may be implemented using any desired type of memory.

In FIG. 7, a time stamp 50 (that identifies the time at which image data 44 was captured) may be encoded in metadata 46 for image 42. Upon receiving an image, control circuitry 14 may extract the time stamp 50 from the metadata and use the time stamp to identify the pose corresponding to the time stamp within pose buffer 52. For example, time stamp 50 may identify a time of day (e.g., 05:12:41.211 PDT) or a relative time (e.g., 145.392 seconds since the video feed commenced). Control circuitry 14 uses the time stamp from the metadata to find the pose with a matching time stamp in pose buffer 52. Control circuitry 14 then uses the pose selected from pose buffer 52 (based on time stamp 50) to determine a position for a representation of image data 44 on display 16.

In some cases, time stamp 50 does not exactly match the time stamp for any pose in pose buffer 52. In this case, the pose with the closest time stamp to time stamp 50 may be used or interpolation may be used to estimate the pose at time stamp 50 (as examples).

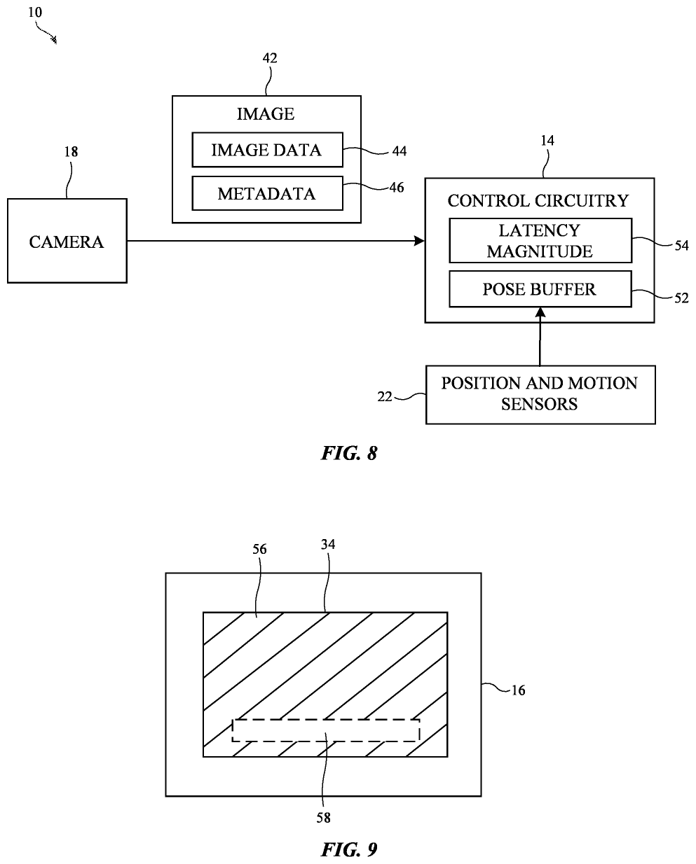

In yet another arrangement, shown in FIG. 8, control circuitry 14 may store a latency magnitude 54 in addition to pose information in pose buffer 52. Latency magnitude 54 may be the average latency associated with camera 18. The latency magnitude may be predetermined based on the type of camera 18 included in head-mounted device (e.g., using testing during manufacturing) or may be calculated during operation of head-mounted device 10.

Control circuitry 14 may receive an image 42 with image data 44 and metadata 46. Control circuitry 14 may then subtract the latency magnitude 54 from the current time to determine an estimated time-of-capture associated with image 42. Control circuitry 14 then extracts the pose associated with the estimated time-of-capture from pose buffer 52 and uses the pose selected from pose buffer 52 to determine a position for a representation of image data 44 on display 16.

In some cases, the estimated time-of-capture for image 42 (determined using latency magnitude 54) does not exactly match the time stamp for any pose in pose buffer 52. In this case, the pose with the closest time stamp to the estimated time-of-capture may be used or interpolation may be used to estimate the pose at the estimated time-of-capture (as examples).

In FIGS. 6-8, it has been described that control circuitry 14 uses an image from camera 18 and a pose associated with the capturing of the image to determine a position for a representation of the image on display 16. It should further be noted that in addition to the pose associated with the capturing of the image, control circuitry 14 may use a second pose (e.g., the most-recent pose, sometimes referred to as the current pose) of head-mounted device 10 to determine the position for the representation of the image on display 16. For example, head-mounted device 10 may sometimes use a difference between the pose associated with the capturing of the image and the current pose to determine the position for the representation of the image on display 16.

A video feed from camera 18 may be displayed on display 16 as part of a camera application. FIG. 9 is a view of an illustrative camera application displayed on display 16. In FIG. 9, a virtual panel 34 is displayed on display 16 (e.g., at an apparent depth from the head-mounted device). A video feed 56 of the physical environment from camera 18 is displayed on virtual panel 34. The virtual panel may be positioned to cause the video feed of the physical environment to overlay corresponding portions of the physical environment. In addition to the camera application displaying the video feed, the camera application may include camera control user interface elements 58 overlayed on video feed 56 on a portion of virtual panel 34. The camera control user interface elements 58 may include one or more user interface elements associated with controlling the camera application. For example, the camera control user interface elements 58 may include a user interface element (e.g., a button) that is selected by the user to capture an image, a user interface element that may be selected to change the zoom of the camera, one or more user interface elements that may be selected to change a mode of the camera, a user interface element that may be selected to cause previously captured images to be displayed, etc.

In contrast with the video feed (where each image of the video feed is positioned based on a pose associated with the capturing of the image), camera control user interface elements 58 may be positioned based on an additional (e.g., current) pose of the head-mounted device 10. Other virtual content may be displayed on display 16 based on the current pose of the head-mounted device 10 in parallel with an image from the video feed being displayed based on the previous pose of the head-mounted device (associated with the capturing of the image). For example, world-locked, body-locked, and/or head-locked virtual content may be displayed on display 16 based on the current pose of the head-mounted device 10 in parallel with the image from the video feed being displayed based on the previous pose of the head-mounted device.

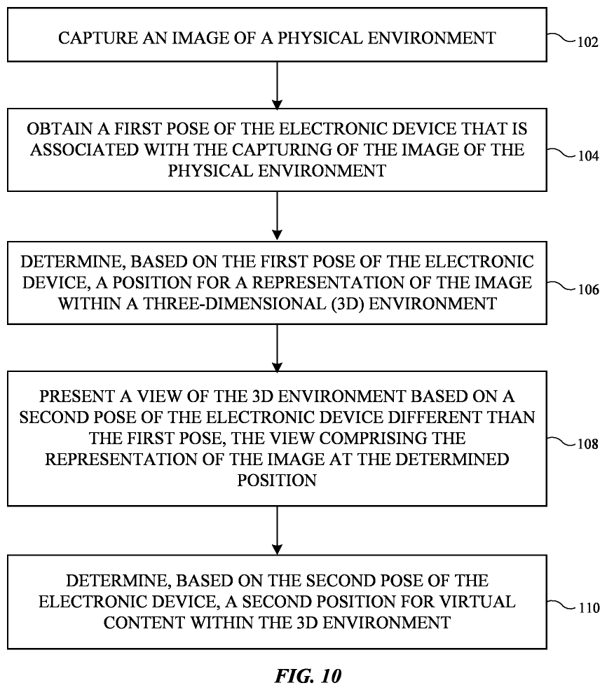

FIG. 10 is a flowchart showing an illustrative method performed by a head-mounted device (e.g., control circuitry 14 in device 10). The blocks of FIG. 10 may be stored as instructions in memory of head-mounted device 10, with the instructions configured to be executed by one or more processors in the electronic device.

At block 102, control circuitry 14 may control a sensor such as camera 18 to capture an image of a physical environment. The camera may be an outward-facing camera on the head-mounted device such that the image of the physical environment is an image of the physical environment surrounding the user of the head-mounted device.

In the example of FIG. 3A, camera 18 on head-mounted device 10 captures an image of a physical environment including physical object 32 at block 102.

At block 104, control circuitry 14 may use a sensor to obtain a first pose of the head-mounted device (sometimes referred to as electronic device). The first pose is associated with the capturing of the image of the physical environment. In other words, the first pose may be the pose of the head-mounted device at the time the image is captured in block 102. The sensor used to obtain the first pose may be the same as the sensor used to capture the image at block 102 (e.g., a camera may be used to both capture the image at block 102 and determine the pose at block 104) or may be different than the sensor used to capture the image at block 102 (e.g., a camera 18 is used to capture the image at block 102 and position and motion sensors 22 are used to determine the pose at block 104). At block 104, control circuitry may obtain the first pose directly from position and motion sensors 22, from the metadata of the image, or from a buffer that stores poses from position and motion sensors 22.

The first pose associated with the capturing of the image of the physical environment may be included in metadata in the image of the physical environment (as in FIG. 6), may be extracted from a pose buffer based on a time stamp in the metadata of the image of the physical environment (as in FIG. 7), or may be determined based on a stored latency magnitude and pose information in a pose buffer (as in FIG. 8).

In the example of FIG. 3A, position and motion sensors 22 on head-mounted device 10 determine a pose of head-mounted device 10 (e.g., with a yaw of angle 38) associated with the capturing of the image of the physical environment including physical object 32. The pose of head-mounted device 10 during the capturing of the image of the physical environment may be encoded in the image of the physical environment as metadata (as in FIG. 6). Alternatively, a time stamp associated with the capturing of the image of the physical environment may be encoded in the image of the physical environment as metadata and the pose of head-mounted device 10 during the capturing of the image of the physical environment may be stored in pose buffer 52 (as in FIG. 7). In yet another alternative, the pose of head-mounted device 10 during the capturing of the image of the physical environment may be stored in pose buffer 52 and control circuitry 14 may obtain the pose using a stored latency magnitude (as in FIG. 8).

At block 106, control circuitry 14 may determine, based on the first pose of the electronic device, a position for a representation of the image (from block 102) within a three-dimensional (3D) environment. The three-dimensional environment may be the physical environment that is viewable through transparent display 16. In another possible embodiment, the three-dimensional environment may be a virtual three-dimensional environment presented using display 16. Control circuitry 14 may select a position for the representation of the image that causes the representation of the image to overlay a corresponding portion of the 3D environment when viewed from the second pose.

In the example of FIGS. 5A and 5B, at block 106 control circuitry 14 determines a position for virtual panel 34 (that includes a representation of the image from block 102) based on the first pose of the electronic device (e.g., the pose from FIG. 3A when the image is captured). Control circuitry 14 determines a position for virtual panel 34 that causes the representation of the image (e.g., the image 32′ of physical object 32) to overlay a corresponding portion of the 3D environment (e.g., corresponding physical object 32) when viewed from the second pose (e.g., with a yaw of angle 40 in FIG. 5A).

At block 108, the control circuitry 14 presents (using transparent display 16) a view of the 3D environment based on a second pose of the electronic device different than the first pose. The second pose may be determined using position and motion sensors 22, as one example. The view may include the representation of the image at the determined position from block 106. The view presented at block 108 may include a view of the physical environment through transparent display 16 at the second pose in an embodiment where display 16 is transparent. In another possible embodiment, the view presented at block 108 may be a view of the virtual 3D environment (and display 16 may optionally be opaque).

The representation of the image presented at block 108 may be part of a camera application within the 3D environment. Displaying the representation of the image as part of a camera application may include displaying camera control user interface elements in addition to the representation of the image. The camera control user interface elements may include a user interface element (e.g., a button) that is selected by the user to capture an image, a user interface element that may be selected to change the zoom of the camera, one or more user interface elements that may be selected to change a mode of the camera, a user interface element that may be selected to cause previously captured images to be displayed, etc. The camera control user interface elements may be displayed at a location determined based on the second pose.

In the example of FIGS. 5A and 5B, a view of the physical environment through the transparent display is presented at block 108 based on the second pose (e.g., with a yaw of angle 40). The view includes a virtual panel 34 with the image (e.g., the image 32′ of physical object 32) at the position from block 106 which causes the image to overlay a corresponding portion of the physical environment (e.g., image 32′ overlays physical object 32 when viewed through display 16).

At optional block 110, control circuitry 14 may determine, based on the second pose of the electronic device, a second position for virtual content within the 3D environment. The view presented based on the second pose (e.g., at block 108) may include the representation of the image at the determined position and the virtual content at the second position. The virtual content at block 110 may include world-locked, head-locked, and/or body-locked content that is positioned at least partially based on the second pose.

Out of an abundance of caution, it is noted that to the extent that any implementation of this technology involves the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device comprising:
one or more sensors;
one or more displays;
one or more processors; and
memory storing instructions configured to be executed by the one or more processors, the instructions for:
capturing, using a first subset of the one or more sensors, an image of a physical environment;
obtaining, using a second subset of the one or more sensors, a first pose of the electronic device, wherein the first pose is associated with the capturing of the image of the physical environment;
determining, based on the first pose of the electronic device, a position for a representation of the image within a three-dimensional (3D) environment; and
presenting, using the one or more displays, a view of the 3D environment based on a second pose of the electronic device different than the first pose, wherein the view comprises the representation of the image at the determined position.

2. The electronic device defined in claim 1, wherein the three-dimensional environment is the physical environment.

3. The electronic device defined in claim 1, wherein the first pose of the electronic device is incorporated as metadata in the image of the physical environment and wherein the instructions further comprise instructions for:
before determining the position for the representation of the image, extracting the first pose of the electronic device from the metadata in the image of the physical environment.

4. The electronic device defined in claim 1, wherein the instructions further comprise instructions for:
storing time-stamped poses of the electronic device for a given duration of time in a buffer.

5. The electronic device defined in claim 4, wherein a time stamp for the image is incorporated as metadata in the image of the physical environment and wherein the instructions further comprise instructions for, before determining the position for the representation of the image:
extracting the time stamp for the image from the metadata in the image of the physical environment; and
extracting the first pose of the electronic device from the buffer using the time stamp.

6. The electronic device defined in claim 4, wherein the instructions further comprise instructions for:
before determining the position for the representation of the image, extracting the first pose of the electronic device from the buffer using a stored latency magnitude, wherein extracting the first pose of the electronic device from the buffer using the stored latency magnitude comprises:
subtracting the stored latency magnitude from a current time.

7. The electronic device defined in claim 1, wherein the position for the representation of the image is configured to cause the representation of the image to overlay a corresponding portion of the 3D environment when viewed from the second pose.

8. The electronic device defined in claim 1, wherein presenting the view of the 3D environment comprises displaying the representation of the image as part of a camera application within the 3D environment, wherein displaying the representation of the image as part of a camera application comprises displaying camera control user interface elements in addition to the representation of the image, and wherein the camera control user interface elements are displayed at a location determined based on the second pose.

9. A method of operating an electronic device that comprises one or more sensors and one or more displays, the method comprising:
capturing, using a first subset of the one or more sensors, an image of a physical environment;
obtaining, using a second subset of the one or more sensors, a first pose of the electronic device, wherein the first pose is associated with the capturing of the image of the physical environment;
determining, based on the first pose of the electronic device, a position for a representation of the image within a three-dimensional (3D) environment; and
presenting, using the one or more displays, a view of the 3D environment based on a second pose of the electronic device different than the first pose, wherein the view comprises the representation of the image at the determined position.

10. The method defined in claim 9, wherein the three-dimensional environment is the physical environment.

11. The method defined in claim 9, wherein the first pose of the electronic device is incorporated as metadata in the image of the physical environment and wherein the method further comprises:
before determining the position for the representation of the image, extracting the first pose of the electronic device from the metadata in the image of the physical environment.

12. The method defined in claim 9, further comprising:
storing time-stamped poses of the electronic device for a given duration of time in a buffer.

13. The method defined in claim 12, wherein a time stamp for the image is incorporated as metadata in the image of the physical environment and wherein the method further comprises, before determining the position for the representation of the image:
extracting the time stamp for the image from the metadata in the image of the physical environment; and
extracting the first pose of the electronic device from the buffer using the time stamp.

14. The method defined in claim 12, further comprising:
before determining the position for the representation of the image, extracting the first pose of the electronic device from the buffer using a stored latency magnitude, wherein extracting the first pose of the electronic device from the buffer using the stored latency magnitude comprises:
subtracting the stored latency magnitude from a current time.

15. The method defined in claim 9, wherein the position for the representation of the image is configured to cause the representation of the image to overlay a corresponding portion of the 3D environment when viewed from the second pose.

16. The method defined in claim 9, wherein presenting the view of the 3D environment comprises displaying the representation of the image as part of a camera application within the 3D environment, wherein displaying the representation of the image as part of a camera application comprises displaying camera control user interface elements in addition to the representation of the image, and wherein the camera control user interface elements are displayed at a location determined based on the second pose.

17. A non-transitory computer-readable storage medium storing one or more programs configured to be executed by one or more processors of an electronic device that comprises one or more sensors and one or more displays, the one or more programs including instructions for:
capturing, using a first subset of the one or more sensors, an image of a physical environment;
obtaining, using a second subset of the one or more sensors, a first pose of the electronic device, wherein the first pose is associated with the capturing of the image of the physical environment;
determining, based on the first pose of the electronic device, a position for a representation of the image within a three-dimensional (3D) environment; and
presenting, using the one or more displays, a view of the 3D environment based on a second pose of the electronic device different than the first pose, wherein the view comprises the representation of the image at the determined position.

18. The non-transitory computer-readable storage medium defined in claim 17, wherein the three-dimensional environment is the physical environment.

19. The non-transitory computer-readable storage medium defined in claim 17, wherein the first pose of the electronic device is incorporated as metadata in the image of the physical environment and wherein the instructions further comprise instructions for:
before determining the position for the representation of the image, extracting the first pose of the electronic device from the metadata in the image of the physical environment.

20. The non-transitory computer-readable storage medium defined in claim 17, wherein the instructions further comprise instructions for:
storing time-stamped poses of the electronic device for a given duration of time in a buffer.

21. The non-transitory computer-readable storage medium defined in claim 20, wherein a time stamp for the image is incorporated as metadata in the image of the physical environment and wherein the instructions further comprise instructions for, before determining the position for the representation of the image:
extracting the time stamp for the image from the metadata in the image of the physical environment; and
extracting the first pose of the electronic device from the buffer using the time stamp.

22. The non-transitory computer-readable storage medium defined in claim 20, wherein the instructions further comprise instructions for:
before determining the position for the representation of the image, extracting the first pose of the electronic device from the buffer using a stored latency magnitude, wherein extracting the first pose of the electronic device from the buffer using the stored latency magnitude comprises:
subtracting the stored latency magnitude from a current time.

23. The non-transitory computer-readable storage medium defined in claim 17, wherein the position for the representation of the image is configured to cause the representation of the image to overlay a corresponding portion of the 3D environment when viewed from the second pose.

24. The non-transitory computer-readable storage medium defined in claim 17, wherein presenting the view of the 3D environment comprises displaying the representation of the image as part of a camera application within the 3D environment, wherein displaying the representation of the image as part of a camera application comprises displaying camera control user interface elements in addition to the representation of the image, and wherein the camera control user interface elements are displayed at a location determined based on the second pose.
